(19) United States
(12) Patent Application Publication
(10) Pub. No.: US 2010/0189391 A1
(43) Pub. Date: Jul. 29, 2010

(54) MULTIMODE OPTICAL COMBINER AND PROCESS FOR PRODUCING THE SAME

(75) Inventor: Shinichi Shimotsu, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/916,190

(22) PCT Filed: May 26, 2006
(86) PCT No.: PCT/JP2006/311042

§ 371 Date: Nov. 30, 2007

(30) Foreign Application Priority Data
May 31, 2005 (JP) 2005-158324

(51) Int. Cl. G02B 6/287; B23P 17/00

(52) U.S. Cl. 385/28; 29/592

(57) ABSTRACT

A multimode optical combiner constituted by first and second multimode optical waveguides. The first multimode optical waveguide includes optical waveguide portions and a near-end portion having a single core and an output end. The optical waveguide portions are arranged in a bundle so that none of the at least six optical waveguide portions is located in the center of the bundle. The second multimode optical waveguide has an input end connected to the output end of the first multimode optical waveguide. The numerical aperture NAᵢₙₚᵤₜ and the core diameter Dᵢₙₚᵤₜ of the first multimode optical waveguide at the output end and the numerical aperture NAₒᵤₜₚᵤₜ and the core diameter Dₒᵤₜₚᵤₜ of the second multimode optical waveguide at the input end satisfy the relationship, NAᵢₙₚᵤₜ×Dᵢₙₚᵤₜ NAₒᵤₜₚᵤₜ×Dₒᵤₜₚᵤₜ.

### TECHNICAL FIELD

The present invention relates to a multimode optical combiner which optically combines light beams emitted from light sources, by using multimode optical waveguides. The present invention also relates to a process for producing such a multimode optical combiner.

### BACKGROUND ART

In the conventional systems in which laser beams emitted from a number of emission points are optically combined in a single multimode optical waveguide, the laser beams outputted from multimode optical fibers are coupled at a light-entrance end face of an optical fiber arranged on the output side of the multimode optical fibers, by using an optical means such as a condensing lens.

In addition, the techniques for optically combining light beams by using multimode optical fibers are essential techniques for use with fiber lasers, and are currently under active development. As indicated in U.S. Pat. Nos. 5,864,644, 5,883,992, and 6,434,302, conventionally, in the case where excitation light beams for a fiber laser are combined, a plurality of optical fibers in which the excitation light beams propagate are arranged around a single-mode optical fiber which is located in the center, the plurality of optical fibers for the excitation light beams and the single-mode optical fiber are bundled, and cores in near-end portions of the plurality of optical fibers and the single-mode optical fiber are joined into a single core so that incident laser beams can be combined.

However, in the case where laser beams are combined by using an optical means such as a condensing lens, the light-entrance end face and the light-output end faces of optical fibers on the optical-means side are exposed to the atmosphere. Therefore, contaminants are deposited on the light-entrance end face and the light-output end faces. In addition, the cost of the optical means is unignorable.

In the case where light beams are combined by using the techniques as disclosed in U.S. Pat. Nos. 5,864,644, 5,883,992, and 6,434,302, the single-mode optical fiber and the plurality of optical fibers are bundled so that the plurality of optical fibers are arranged around the single-mode optical fiber, and the single-mode optical fiber and the plurality of optical fibers are in a closest arrangement. Therefore, the number of the optical fibers to be used for optical combining can be calculated in accordance with the formula,

N=1+6×i, (1)

where i is an integer equal to or greater than zero. That is, the number of the optical fibers to be used for optical combining must satisfy the formula (1) (i.e., N=1, 7, 13, 19, . . . ). In other words, the options for the number of optical input ports of light beams to be combined are narrow.

In FIG. 8, the forces which operate when a plurality of optical fibers are bundled are indicated by arrows. As indicated in FIG. 8, the forces exerted on the fibers are not uniform, i.e., the optical fiber 91, which is arranged in the center of the bundle, concentratedly receives the forces. Therefore, the cross-sectional intensity distribution of outputted laser light is not uniform.

In addition, the optical fiber 91 is an optical fiber designed for signal transmission, and is different from the optical fibers surrounding the optical fiber 91. Therefore, the intensity of the outputted light is low in the central portion of its cross section. That is, the difference of the optical fiber 91 from the surrounding optical fibers also causes ununiform cross-sectional intensity distribution of the outputted laser light.

Further, in the case where a lens is used for the optical combining, bothersome work for cleaning and adjustment is necessary, i.e., the time and manpower required for manufacture of the optical combiner increase.

### DISCLOSURE OF INVENTION

The first object of the present invention is to provide a multimode optical combiner which optically combines light beams by using a multimode optical waveguide without use of an optical means such as a condensing lens while providing broad options for the number of optical input ports, and outputs stable combined light having uniform cross-sectional intensity distribution while suppressing loss in the combined light.

The second object of the present invention is to provide a process for producing the multimode optical combiner accomplishing the first object.

In order to accomplish the first object, the first aspect of the present invention is provided. According to the first aspect of the present invention, there is provided a multimode optical combiner comprising: a first multimode optical waveguide and a second multimode optical waveguide. The first multimode optical waveguide includes a plurality of optical waveguide portions and a near-end portion. The plurality of optical waveguide portions are arranged in a bundle so that none of the plurality of optical waveguide portions is located in the center of the bundle. The near-end portion contains a single core, has an output end, and is continuously connected to the optical waveguide portions. The second multimode optical waveguide has an input end connected to the output end of the first multimode optical waveguide. The numerical aperture NAᵢₙₚᵤₜ and the core diameter Dᵢₙₚᵤₜ of the first multimode optical waveguide at the output end satisfy a relationship,

NAᵢₙₚᵤₜ×Dᵢₙₚᵤₜ≦NAₒᵤₜₚᵤₜ×Dₒᵤₜₚᵤₜ. (2)

In addition, in order to accomplish the first object, the second aspect of the present invention is also provided. According to the second aspect of the present invention, there is provided a multimode optical combiner comprising: a first multimode optical waveguide and a second multimode optical waveguide. The first multimode optical waveguide includes a plurality of optical waveguide portions and a near-end portion. The plurality of optical waveguide portions are arranged in a bundle so that none of the plurality of optical waveguide portions is located in the center of the bundle. The near-end portion contains a single core, has an output end, and is continuously connected to the optical waveguide portions. The second multimode optical waveguide has an input end connected to the output end of the first multimode optical waveguide. The numerical aperture NAₒᵤₜₚᵤₜ and the core diameter Dₒᵤₜₚᵤₜ of the second multimode optical waveguide at the input end satisfy aforementioned relationship (2).

Preferably, in the multimode optical combiners according to the first and second aspects of the present invention, the plurality of optical waveguide portions are bundled in a closest arrangement. At this time, the number of the plurality of optical waveguide portions is preferably an integer multiple of three or four.

In order to accomplish the second object, the third aspect of the present invention is provided. According to the third aspect of the present invention, there is provided a process for producing a multimode optical combiner, comprising the steps of: (a) making a bundle of a plurality of multimode optical fibers in such a manner that none of the plurality of multimode optical fibers is located in the center of the bundle; (b) joining a portion of the bundle of the plurality of optical fibers so that a single core is formed in the portion; (c) cutting the bundle of the plurality of multimode optical fibers at a position in the partial length so as to form a first multimode optical waveguide having an output end at the position; and (d) connecting or splicing an input end of a second multimode optical waveguide to the output end of the first multimode optical waveguide. In the above process, the numerical aperture NAᵢₙₚᵤₜ and the core diameter Dᵢₙₚᵤₜ of the first multimode optical waveguide at the output end and the numerical aperture NAₒᵤₜₚᵤₜ and the core diameter Dₒᵤₜₚᵤₜ of the second multimode optical waveguide at the input end satisfy the aforementioned relationship (2).

Preferably, in the third aspect of the present invention, the plurality of multimode optical fibers are bundled in a closest arrangement. At this time, the number of the plurality of multimode optical fibers is preferably an integer multiple of three or four.

The multimode optical combiners according to the first and second aspects of the present invention have the following advantages.
(i) In the first multimode optical waveguide in the multimode optical combiner according to the first or second aspect of the present invention of the present invention, the plurality of optical waveguide portions are bundled so that none of the plurality of optical waveguide portions is located in the center of the bundle, and the multimode optical combiner (according to the first or second aspect of the present invention) is obtained by connecting the second multimode optical waveguide to the first multimode optical waveguide. Therefore, forces are uniformly exerted on the plurality of optical waveguide portions when the plurality of optical waveguide portions are bundled, so that it is possible to uniformize the characteristics of the different channels of the multimode optical combiner and the cross-sectional intensity distribution of the combined light outputted from the multimode optical combiner.
(ii) Since the output end of the first multimode optical waveguide and the input end of the second multimode optical waveguide are formed so that the numerical aperture NAᵢₙₚᵤₜ of the first multimode optical waveguide at the output end, the core diameter Dᵢₙₚᵤₜ of the first multimode optical waveguide at the output end, the numerical aperture NAₒᵤₜₚᵤₜ of the second multimode optical waveguide at the input end, and the core diameter Dₒᵤₜₚᵤₜ of the second multimode optical waveguide at the input end satisfy the aforementioned relationship (2), it is possible to suppress the loss in the combined light outputted from the multimode optical combiner (according to the first or second aspect of the present invention).
(iii) Since the optical means such as a condensing lens is not used for the optical combining, and the light beams inputted into the plurality of optical waveguide portions of the multimode optical combiner (according to the first or second aspect of the present invention) are optically combined in the optical fibers realizing the first multimode optical waveguide, it is possible to stabilize the combined light outputted from the multimode optical combiner, and save the cost of the optical means. In addition, since the portion of the multimode optical combiner in which the light beams are optically combined are not exposed to the atmosphere, it is possible to simplify the cleaning operation.
(iv) In the case where the number of the plurality of optical waveguide portions is an integer multiple of three or four, the options for the number of the optical input ports are broad compared with the conventional multimode optical combiner.

### BRIEF DESCRIPTION OF DRAWINGS

FIGS. 1A to 1D are perspective views schematically illustrating representative stages in a process for producing an input-side optical fiber according to a first embodiment of the present invention.

FIGS. 2A to 2D are cross-sectional views schematically illustrating examples of arrangements of multimode optical fibers in the case where the number of the optical waveguide portions is an integer multiple of three.

FIGS. 3A and 3B are cross-sectional views schematically illustrating examples of arrangements of multimode optical fibers in the case where the number of the optical waveguide portions is an integer multiple of four.

FIG. 4 is a cross-sectional side view schematically illustrating a cross section in the length direction of the multimode optical combiner according to the first embodiment.

FIGS. 5A to 5D are cross-sectional views of the multimode optical combiner according to the first embodiment at representative positions.

FIG. 6 is a cross-sectional side view schematically illustrating a cross section in the length direction of a multimode optical combiner according to a second embodiment of the present invention.

FIG. 7 is a cross-sectional side view schematically illustrating a cross section in the length direction of a multimode optical combiner according to a third embodiment of the present invention.

FIG. 8 is a cross-sectional view of the forces which operate when a plurality of optical fibers are bundled.

### BEST MODE FOR CARRYING OUT THE INVENTION

Preferred embodiments of the present invention are explained in detail below with reference to drawings. In each of the embodiments, an input-side portion of the multimode optical combiner including a plurality of optical waveguide portions and a single output end (corresponding to the aforementioned first multimode optical waveguide) is referred to as an input-side optical fiber, and an output-side portion of the multimode optical combiner into which the light outputted from the input-side optical fiber is inputted (corresponding to the aforementioned second multimode optical waveguide) is referred to as an output-side optical fiber. In addition, although optical fibers are used as the optical waveguides in the following embodiments, it is possible to use other types of optical waveguides which also have a core-cladding structure through which light propagates. Further, in the following embodiments, the light entering the multimode optical combiner is emitted from one or more light sources such as semiconductor lasers, solid-state lasers, gas lasers, or light-emission diodes, and the multimode optical fibers constituting the input-side optical fiber and the output-side optical fiber are made of quartz, glass, or plastic

### First Embodiment

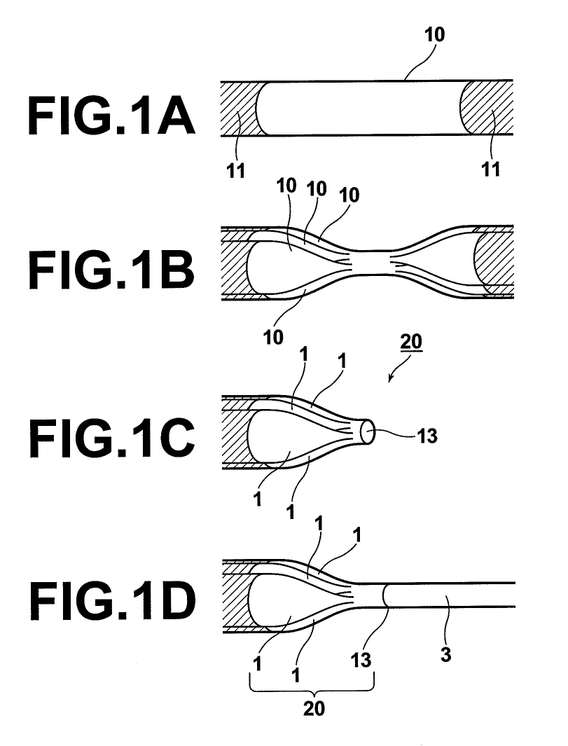

Hereinbelow, a process for producing the multimode optical combiner according to the first embodiment of the present invention is explained with reference to FIGS. 1A through 5C.

FIGS. 1A to 1D are perspective views schematically illustrating representative stages in the process for producing the input-side optical fiber according to the first embodiment.

First, the coating 11 in a predetermined portion of each of a plurality of multimode optical fibers 10 is removed as illustrated in FIG. 1A. Then, the plurality of multimode optical fibers 10 are bundled in a closest arrangement so that none of the multimode optical fibers 10 is located in the center of the bundle. The number of the multimode optical fibers 10 and the manners of the closest arrangement are explained later. Subsequently, the predetermined portions of the multimode optical fibers 10 in which the coating 11 is removed are softened by heating so that the cores of the multimode optical fibers 10 in the heated portions are joined into a single core.

Thereafter, the bundle of the multimode optical fibers 10 are pulled from both ends so as to elongate the softened portion of the bundle of the multimode optical fibers 10 as illustrated in FIG. 1B. The diameter of the softened portion of the bundle of the multimode optical fibers 10 is reduced by the elongation, so that a tapered structure is formed in the bundle of the multimode optical fibers 10. In the tapered structure, the diameter of the softened portion of the bundle of the multimode optical fibers 10 is smaller than the diameters of both ends of the bundle of the multimode optical fibers 10. When the diameter of the bundle of the multimode optical fibers 10 is reduced, the confinement of light propagating through the bundle of the multimode optical fibers 10 is weakened. Therefore, it is possible to decrease the mode field diameter. At this time, it is sufficient for the heated and softened portion of the bundle of the multimode optical fibers 10 to have a length of approximately 3 mm. In the case where the heated and softened portion of the bundle of the multimode optical fibers 10 have a length of approximately 3 to 20 mm, it is possible to realize a slow taper structure when the multimode optical fibers 10 near the position of an output end 13 of the input-side optical fiber 20 are joined. Therefore, the loss in the combined light can be reduced.

Next, the bundle of the multimode optical fibers 10 is cut so as to produce the input-side optical fiber 20 having the output end 13 as illustrated in FIG. 1C. That is, the cut surface of the bundle of the multimode optical fibers 10 becomes the output end 13 of the input-side optical fiber 20, which is to be joined to an input end of an output-side optical fiber 3. The output end 13 of the input-side optical fiber 20 is formed at such a position that the numerical aperture NAᵢₙₚᵤₜ and the core diameter Dᵢₙₚᵤₜ of the input-side optical fiber 20 at the output end 13 satisfy the relationship,

NAᵢₙₚᵤₜ×Dᵢₙₚᵤₜ≦NAₒᵤₜₚᵤₜ×Dₒᵤₜₚᵤₜ, (2)

where NAₒᵤₜₚᵤₜ and Dₒᵤₜₚᵤₜ are respectively the numerical aperture and the core diameter of the output-side optical fiber 3 at the input end. Then, the output end 13 of the input-side optical fiber 20 is joined to the input end of the output-side optical fiber 3 by fusion or the like as illustrated in FIG. 1D. Thus, the multimode optical combiner 4 according to the first embodiment of the present invention is obtained. Hereinafter, the portion of each of the multimode optical fibers 10 which is not joined to another of the multimode optical fibers 10 is referred to as an optical waveguide portion 1.

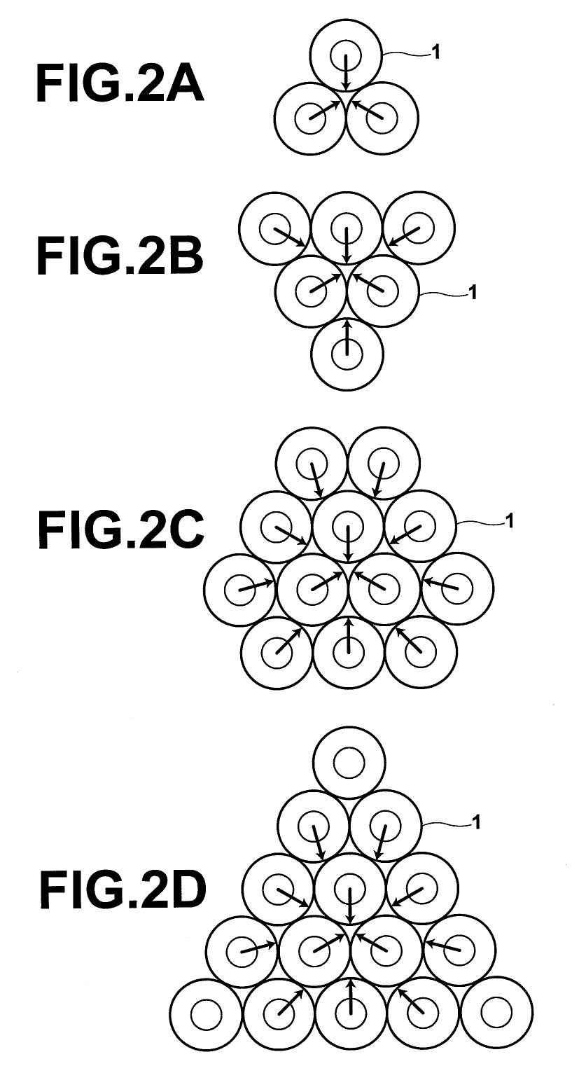

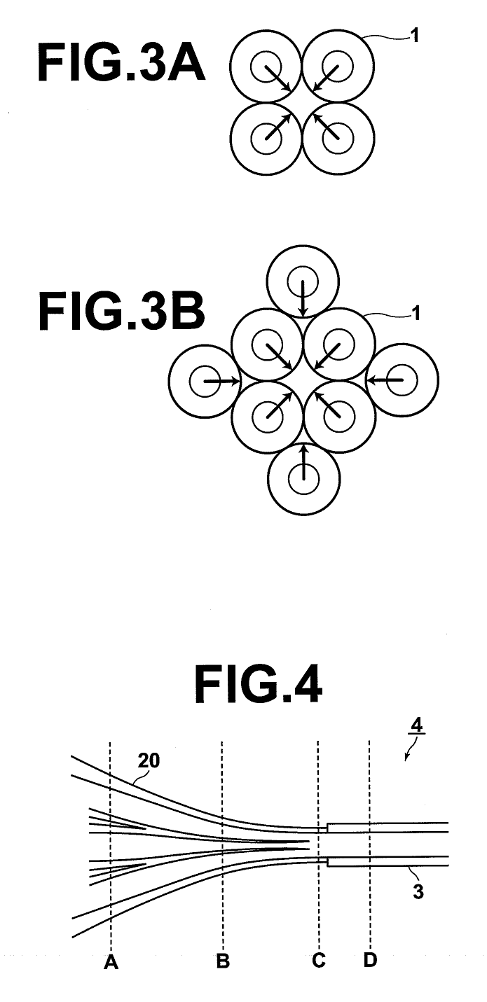

FIGS. 2A to 2D, 3A, and 3B show examples of arrangements of the multimode optical fibers 1. In each of FIGS. 2A to 2D, 3A, and 3B, a cross section of an example of the bundle of the optical waveguide portions 1 perpendicular to the length direction of the multimode optical combiner is shown, and each double circle indicates a cross section of one of the optical waveguide portions 1 (although only one of the optical waveguide portions 1 bears the reference Ò1Ó for simple illustration).

As illustrated in each of FIGS. 2A to 2D, 3A, and 3B, none of the optical waveguide portions 1 is located in the center of the bundle (i.e., in the center in the directions perpendicular to the length direction of the multimode optical combiner). The number N of the optical waveguide portions 1 is determined in accordance with either of the formulas,

N=3×j, and (3)

N=4×j, (4)

where j is an integer greater than zero. In the case where the number N of the optical waveguide portions 1 is an integer multiple of three or four, the optical waveguide portions 1 can be arranged so that none of the multimode optical fibers 10 is located in the center of the bundle of the optical waveguide portions 1. FIGS. 2A to 2D show examples of arrangements of the optical waveguide portions 1 in the case where the number of the optical waveguide portions is an integer multiple of three, and FIGS. 3A and 3B show examples of arrangements of the optical waveguide portions 1 in the case where the number of the optical waveguide portions is an integer multiple of four.

In the case where the optical waveguide portions 1 are bundled so that none of the multimode optical fibers 10 is located in the center of the bundle of the optical waveguide portions 1, it is possible to uniformize the forces exerted on the multimode optical fibers 10 during the process of heating and softening the aforementioned portions of the multimode optical fibers 10. Therefore, it is possible to uniformize the cross-sectional intensity distribution of the combined light. In addition, no optical fiber designed for signal transmission is used, and all the multimode optical fibers 10 used for the optical combining are optical fibers having identical characteristics. This feature also supports the uniformness of the cross-sectional intensity distribution of the combined light.

Further, the number of the optical waveguide portions 1 can be chosen from an integer multiples of three or four according to the present embodiment, while, according to the conventional techniques, the number of the optical fibers to be used for optical combining is required to be chosen from the numbers satisfying the aforementioned formula (1). That is, according to the present embodiment, the options for the number of optical waveguide portions into which light beams from light sources are inputted are broad compared with the conventional multimode optical combiner.

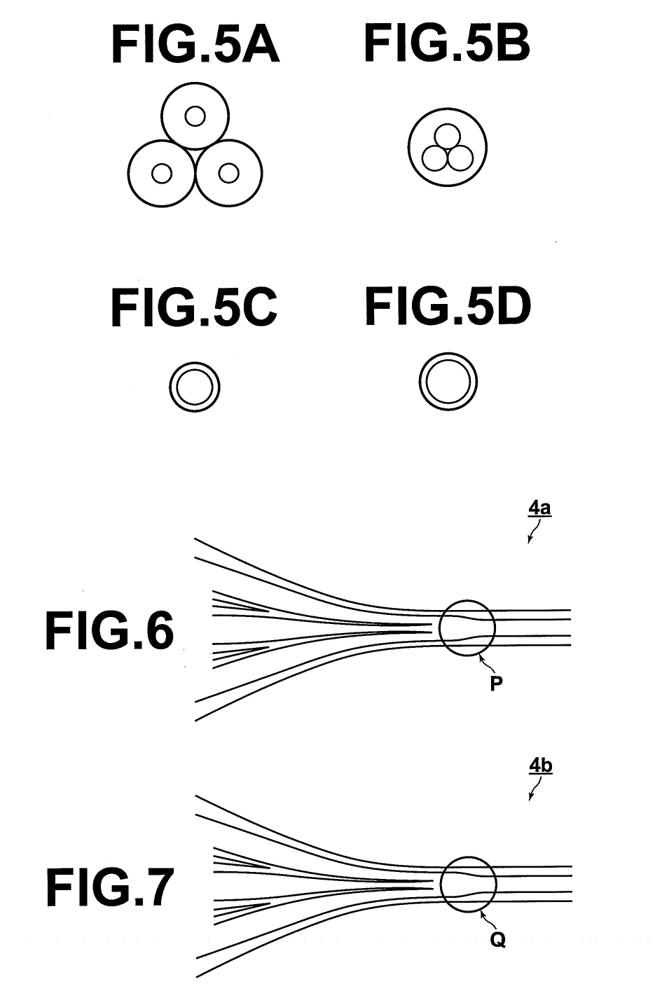

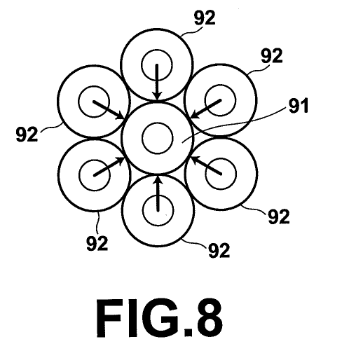

FIG. 4 shows a cross section in the length direction of the multimode optical combiner 4 according to the first embodiment which is constructed as explained above, and FIGS. 5A to 5D show cross sections of the multimode optical combiner 4 at the positions which are respectively indicated in FIG. 4 by the dashed lines A, B, C, and D, where the cross sections are perpendicular to the length direction of the multimode optical combiner 4.

At the position A, the multimode optical fibers 10 constituting the input-side optical fiber 20 has a step-index structure in which a steplike change in the refractive index occurs at the boundary between each core and the cladding surrounding the core in the input-side optical fiber 20. The positions B and C belong to the aforementioned portion which is heated and elongated. Therefore, dopant atoms in the vicinity of the core-cladding boundary are diffused by heat so that the distribution of the refractive index becomes smooth. Further, when the outer diameter of the multiple optical combiner 4 becomes small as illustrated in FIG. 5C, light propagates through approximately the entire cross section of the multiple optical combiner 4.

The present inventor has measured the loss in three multimode optical combiners which are produced as explained above. Specifically, the first multimode optical combiner is produced as follows. First, an input-side optical fiber is formed by bundling six multimode optical fibers and joining the multimode optical fibers in a partial length of the bundle near an output end into a single core, and is then connected to an output-side optical fiber, where the numerical aperture NAᵢₙₚᵤₜ at the output end of the input-side optical fiber is 0.15, the core diameter Dᵢₙₚᵤₜ at the output end of the input-side optical fiber is 50 micrometers, the numerical aperture NAₒᵤₜₚᵤₜ at the input end of the output-side optical fiber is 0.22, and the core diameter Dₒᵤₜₚᵤₜ at the input end of the output-side optical fiber is 200 micrometers. The measured loss in the combined light outputted from the first multimode optical combiner is 5% or less.

The second multimode optical combiner is different from the first multimode optical fiber in that the number of the multimode optical fibers bundled in the input-side optical fiber is nine. The measured loss in the combined light outputted from the second multimode optical combiner is 15% or less.

The third multimode optical combiner is different from the first multimode optical fiber in that the number of the multimode optical fibers bundled in the input-side optical fiber is twelve. The measured loss in the combined light outputted from the second multimode optical combiner is 30% or less.

As explained above, the multimode optical combiner 4 according to the first embodiment of the present invention is produced by bundling the plurality of multimode optical fibers 10 so that none of the multimode optical fibers 10 is located in the center of the bundle, joining the cores of the multimode optical fibers 10 in a partial length of the bundle into a single core through the heating and elongation processes, cutting the portion (single-core portion) containing the single core so as to form the output end 13 of the input-side optical fiber 20, and connecting the output-side optical fiber 3 to the output end 13. Therefore, forces are uniformly exerted on the multimode optical fibers 10 when the multimode optical fibers 10 are bundled, so that it is possible to uniformize the characteristics of the different channels and the cross-sectional intensity distribution of the combined light. In addition, since the multimode optical fibers 10 in a partial length of the bundle are jointed into a single-core portion through the softening and elongation processes, and the single-core portion is cut at such a position that the relationship (2) is satisfied, and the output-side optical fiber 3 is connected to the cut surface, it is possible to suppress the loss in the combined light.

Further, the light beams are combined in the optical fibers constituting the multimode optical combiner 4 without use of an optical means such as the condensing lens. Therefore, it is possible to obtain stable combined light, save the cost of the optical means, and prevent performance deterioration caused by contamination of the light-entrance end face and the light-output end faces, which are exposed to the atmosphere in the case where the optical means is used.

### Second Embodiment

The multimode optical combiners according to the present invention can be produced by other processes. Hereinbelow, a process for producing a multimode optical combiner according to the second embodiment of the present invention is explained with reference to FIG. 6.

First, a plurality of multimode optical fibers are bundled, and the multimode optical fibers in a partial length of the bundle are joined into a single core, in a similar manner to the first embodiment. Then, an input-side optical fiber is produced by cutting the joined portion of the bundle of the multimode optical fibers at a position at which the core diameter is greater than the core diameter at the input end of the output-side optical fiber. The cut surface of the input-side optical fiber becomes the output end. Next, the output end of the input-side optical fiber is joined to the input end of the output-side optical fiber by fusion or the like. Then, in order to suppress the loss in the combined light, the profile of the portion at which the input-side optical fiber is joined to the output-side optical fiber is smoothed by a process of heating, discharging, or the like. Thus, the multimode optical combiner 4a according to the second embodiment is obtained. FIG. 6 shows a cross section in the length direction of the multimode optical combiner 4a. In FIG. 6, the portion of the multimode optical combiner 4a the profile of which is smoothed by the above process of heating, discharging, or the like is indicated in the circle bearing the reference P.

Since the output end of the input-side optical fiber is formed by cutting the joined portion of the bundle of the multimode optical fibers at a position at which the core diameter is greater than the core diameter at the input end of the output-side optical fiber, and the input end of the output-side optical fiber is joined to the output end, it is possible to produce a multimode optical combiner having low coupling loss.

### Third Embodiment

Next, a process for producing a multimode optical combiner according to the third embodiment of the present invention is explained with reference to FIG. 7.

First, a plurality of multimode optical fibers are bundled, and the multimode optical fibers in a partial length of the bundle are joined into a single core, in a similar manner to the first embodiment. Then, an input-side optical fiber is produced by cutting the joined portion of the bundle of the multimode optical fibers at a position at which the core diameter is greater than the core diameter at the input end of the output-side optical fiber. The cut surface of the input-side optical fiber becomes the output end. Next, the core diameter of the input end of the output-side optical fiber is increased by a process of heat diffusion or the like so that the output end of the input-side optical fiber and the input end of the output-side optical fiber satisfy the aforementioned relationship (2). Thereafter, the output end of the input-side optical fiber is joined to the input end of the output-side optical fiber by fusion or the like. Thus, the multimode optical combiner 4b according to the third embodiment is obtained. Since the relationship (2) is satisfied, it is possible to suppress the loss in the combined light. FIG. 7 shows a cross section in the length direction of the multimode optical combiner 4b. In FIG. 7, the portion of the output-side optical fiber in which the core diameter is increased is indicated in the circle bearing the reference Q.

Since the output end of the input-side optical fiber is formed by cutting the portion of the bundle of the multimode optical fibers containing the single core at a position at which the core diameter is greater than the core diameter at the input end of the output-side optical fiber, and the input end of the output-side optical fiber at which the core diameter is increased is joined to the output end of the input-side optical fiber, the tolerance for axial misalignment increases in the operation of connecting the output-side optical fiber to the input-side optical fiber. Therefore, it is possible to realize a stable multimode optical combiner.

1-10. (canceled)

11. A multimode optical combiner comprising:
a first multimode optical waveguide which includes,
a plurality of optical waveguide portions arranged in a bundle so that none of the plurality of optical waveguide portions is located in the center of the bundle, the number of optical waveguide portions being at least six, and
a near-end portion containing a single core, having an output end, and being continuously connected to said plurality of optical waveguide portions; and
a second multimode optical waveguide having an input end connected to the output end of the first multimode optical waveguide;
wherein said first multimode optical waveguide has a numerical aperture NAᵢₙₚᵤₜ and a core diameter Dᵢₙₚᵤₜ at said output end, said second multimode optical waveguide has a numerical aperture NAₒᵤₜₚᵤₜ and a core diameter Dₒᵤₜₚᵤₜ at the input end, and the numerical aperture NAᵢₙₚᵤₜ and the core diameter Dᵢₙₚᵤₜ satisfy a relationship, NAᵢₙₚᵤₜ×Dᵢₙₚᵤₜ≦NAₒᵤₜₚᵤₜ×Dₒᵤₜₚᵤₜ.

12. A multimode optical combiner according to claim 11, wherein the number of said plurality of optical waveguide portions is an integer multiple of three, and the plurality of optical waveguide portions are bundled in a closest arrangement.

13. A multimode optical combiner according to claim 11, wherein the number of said plurality of optical waveguide portions is an integer multiple of four, and the plurality of optical waveguide portions are bundled in a closest arrangement.

14. A multimode optical combiner comprising:
a first multimode optical waveguide which includes,
a plurality of optical waveguide portions arranged in a bundle so that none of the plurality of optical waveguide portions is located in the center of the bundle, the number of optical waveguide portions being at least six, and
a near-end portion containing a single core, having an output end, and being continuously connected to said plurality of optical waveguide portions; and
a second multimode optical waveguide having an input end connected to the output end of the first multimode optical waveguide;
wherein said first multimode optical waveguide has a numerical aperture NAᵢₙₚᵤₜ and a core diameter Dᵢₙₚᵤₜ at said output end, said second multimode optical waveguide has a numerical aperture NAₒᵤₜₚᵤₜ and a core diameter Dₒᵤₜₚᵤₜ at the input end, and the numerical aperture NAₒᵤₜₚᵤₜ and the core diameter Dₒᵤₜₚᵤₜ satisfy a relationship, NAᵢₙₚᵤₜ×Dᵢₙₚᵤₜ≦NAₒᵤₜₚᵤₜ×Dₒᵤₜₚᵤₜ.

15. A multimode optical combiner according to claim 14, wherein the number of said plurality of optical waveguide portions is an integer multiple of three, and the plurality of optical waveguide portions are bundled in a closest arrangement.

16. A multimode optical combiner according to claim 14, wherein the number of said plurality of optical waveguide portions is an integer multiple of four, and the plurality of optical waveguide portions are bundled in a closest arrangement.

17. A multimode optical combiner according to claim 11, wherein said plurality of optical waveguide portions included in the first multimode optical waveguide are arranged in such a manner that they are in contact with each other, and such that more than one of said optical waveguide portions have a maximum number of portions thereof in contact with the other optical waveguide portions.

18. A multimode optical combiner according to claim 12, wherein said plurality of optical waveguide portions included in the first multimode optical waveguide are arranged in such a manner that they are in contact with each other, and such that more than one of said optical waveguide portions have a maximum number of portions thereof in contact with the other optical waveguide portions.

19. A multimode optical combiner according to claim 13, wherein said plurality of optical waveguide portions included in the first multimode optical waveguide are arranged in such a manner that they are in contact with each other, and such that more than one of said optical waveguide portions have a maximum number of portions thereof in contact with the other optical waveguide portions.

20. A multimode optical combiner according to claim 14, wherein said plurality of optical waveguide portions included in the first multimode optical waveguide are arranged in such a manner that they are in contact with each other, and such that more than one of said optical waveguide portions have a maximum number of portions thereof in contact with the other optical waveguide portions.

21. A multimode optical combiner according to claim 15, wherein said plurality of optical waveguide portions included in the first multimode optical waveguide are arranged in such a manner that they are in contact with each other, and such that more than one of said optical waveguide portions have a maximum number of portions in contact with the other optical waveguide portions.

22. A multimode optical combiner according to claim 16, wherein said plurality of optical waveguide portions included in the first multimode optical waveguide are arranged in such a manner that they are in contact with each other, and such that more than one of said optical waveguide portions have a maximum number of portions in contact with the other optical waveguide portions.

23. A process for producing a multimode optical combiner, comprising the steps of:
(a) making a bundle of a plurality of multimode optical fibers in such a manner that none of the plurality of multimode optical fibers is located in the center of the bundle, the number of optical fibers being at least six,;
(b) joining the plurality of optical fibers in a partial length of the bundle so that a single core is formed in the portion;
(c) cutting said bundle of the plurality of multimode optical fibers at a position in said partial length so as to form a first multimode optical waveguide having an output end at the position; and
(d) connecting or splicing an input end of a second multimode optical waveguide to said output end of the first multimode optical waveguide;
wherein said first multimode optical waveguide has a numerical aperture NAᵢₙₚᵤₜ and a core diameter Dᵢₙₚᵤₜ at the output end, said second multimode optical waveguide has a numerical aperture NAₒᵤₜₚᵤₜ and a core diameter Dₒᵤₜₚᵤₜ at the input end, and the numerical aperture NAᵢₙₚᵤₜ, the core diameter Dᵢₙₚᵤₜ, the numerical aperture NAₒᵤₜₚᵤₜ, and the core diameter Dₒᵤₜₚᵤₜ satisfy a relationship, NAᵢₙₚᵤₜ×Dᵢₙₚᵤₜ≦NAₒᵤₜₚᵤₜ×Dₒᵤₜₚᵤₜ.

24. A process according to claim 23, further comprising the step of (e) elongating and thinning said partial length of the bundle after said step (b).

25. A process according to claim 23, wherein the number of said plurality of multimode optical fibers is an integer multiple of three, and the plurality of multimode optical fibers in said bundle are in a closest arrangement.

26. A process according to claim 23, wherein the number of said plurality of multimode optical fibers is an integer multiple of four, and the plurality of multimode optical fibers in said bundle are in a closest arrangement.

27. A process according to claim 23, wherein a plurality of optical waveguide portions included in the first multimode optical waveguide are arranged in such a manner that they are in contact with each other, and such that more than one of said optical waveguide portions have a maximum number of portions thereof in contact with the other optical waveguide portions.
